(19) United States
(12) Patent Application Publication
(10) Pub. No.: US 2014/0365824 A1
(43) Pub. Date: Dec. 11, 2014

(54) METHOD FOR RECOVERING HARD DISK DATA, SERVER AND DISTRIBUTED STORAGE SYSTEM

(71) Applicant: TENCENT TECHNOLOGY (SHENZHEN) COMPANY LIMITED, Shenzhen City, Guangdong (CN)

(72) Inventors: Haibing Huang, Shenzhen City (CN); Jibing Lou, Shenzhen City (CN); Jie Chen, Shenzhen City (CN)

(73) Assignee: TENCENT TECHNOLOGY (SHENZHEN) COMPANY LIMITED, Shenzhen City, Guangdong (CN)

(21) Appl. No.: 14/372,662

(22) PCT Filed: Jan. 5, 2013
(86) PCT No.: PCT/CN2013/070046

§ 371 Date: Jul. 16, 2014

(30) Foreign Application Priority Data
Jan. 20, 2012 (CN) 201210018857.7

(51) Int. Cl. G06F 11/14

(52) U.S. Cl. CPC G06F 11/1469; G06F 11/1464
USPC 714/20

(57) ABSTRACT

A method for recovering hard disk data, a server and a distributed storage system relate to a computer technology. In the method, a data recovery request is received. The request includes at least one ID of sectors whose data is to be recovered. Based on the at least one ID of the sectors whose data is to be recovered, at least one sector whose data is to be recovered is located. Obtain at least one standby sector ID and a file backup corresponding to the at least one ID of the sectors whose data is to be recovered, and locate at least one standby sector based on the at least one standby sector ID. Write, into the at least one standby sector, data that is in the file backup and the same as the data stored in the at least one sector whose data is to be recovered.

### CROSS-REFERENCE TO RELATED APPLICATIONS

This application is a national phase application of PCT Application No. PCT/CN2013/070046, which claims priority of a Chinese patent application No. 201210018857.7, entitled “hard disk data recovery method, server and distributed storage system,” submitted to the State Intellectual Property Office on Jan. 20, 2012, the entirety of which is incorporated herein by reference.

### FIELD OF THE TECHNOLOGY

The disclosure relates to computer technologies, and especially, to a method for recovering hard disk data, a server and a distributed storage system.

### BACKGROUND

As a data storage device, a hard disk is an indispensable physical device in a computer. Generally, the hard disk includes a head and a magnetic disk. When the hard disk is working, the head reads data by sensing changes of the magnetic field on the rotating disk, and writes data by changing the magnetic field on the disk. The head makes a lot of circular tracks on the surface of the disk, and each circular track is divided into several segmental arcs of equal length. Such segmental arc is called a sector. Data of the hard disk is stored on the magnetic disk with sector as a unit. If the head has any fault or power failure occurs while the hard disk is in operation, one or more sectors on the hard disk will be damaged.

In order to provide corresponding data protection when any sector is damaged, the existing data storage system adopts a distributed storage system. In the distributed storage system, data is backed up to hard disks of at least two servers at the same time. At least two servers are mutually peer servers. If any sector of a hard disk in a server on which data is stored can not be read, the data needs to be recovered. The existing hard disk data recovery method is to replace the hard disk with a bad sector. Specifically, data from the peer server is copied to a new hard disk, and the original hard disk is replaced with the new hard disk.

### SUMMARY

In order to recover hard disk data quickly and reduce enterprise operation cost, a method for recovering hard disk data, a server and a distributed storage system are provided in embodiments of the disclosure. The technical solution is as follows.

A method for recovering hard disk data for a server includes:

receiving a data recovery request, wherein the data recovery request includes at least one identity (ID) of sectors whose data is to be recovered, and locating at least one sector whose data is to be recovered based on the at least one ID of the sectors whose data is to be recovered;

acquiring at least one standby sector ID and a file backup corresponding to the at least one ID of the sectors whose data is to be recovered, and locating at least one standby sector based on the at least one standby sector ID; and

writing data that is in the file backup and the same as the data stored in the at least one sector whose data is to be recovered into the at least one standby sector.

A server includes:

a receiving module, configured to receive a data recovery request, wherein the data recovery request includes at least one ID of sectors whose data is to be recovered, and locate at least one sector whose data is to be recovered based on the at least one ID of the sectors whose data is to be recovered;

an acquiring module, configured to acquire at least one standby sector ID and a file backup corresponding to the at least one ID of the sectors whose data is to be recovered, and locate at least one standby sector based on the at least one standby sector ID; and

a writing module, configured to write data that is in the file backup and the same as the data stored in the at least one sector whose data is to be recovered into the at least one standby sector.

A distributed storage system includes: at least two servers;

wherein at least one server among the at least two servers is a mirror server of another server among the at least two servers, and the anther server is the serve as described above.

The technical solution provided by the embodiment of the disclosure has the following benefits. By receiving the data recovery request including at least one ID of sectors whose data is to be recovered, at least one sector whose data is to be recovered is located based on the at least one ID of the sectors whose data is to be recovered. Obtain at least one standby sector ID and a file backup corresponding to the at least one ID of the sectors whose data is to be recovered, and locate at least one standby sector based on the at least one standby sector ID. Since the size of the file backup is small relative to the entire hard disk data, the file backup can be obtained quickly, and data that is in the file backup and the same as the data stored in the at least one sector whose data is to be recovered can be written into the at least one standby sector. The data stored in the sectors whose data is to be recovered can be quickly recovered by using standby sectors of a hard disk. The cost of business operations is reduced by eliminating the necessity of changing the entire hard disk.

### BRIEF DESCRIPTION OF DRAWINGS

In order to illustrate the technical solution in the embodiments of the disclosure more clear, drawings used in description of the embodiments are introduced briefly below. Obviously, the drawings hereinafter described are only some of the embodiments of the disclosure. Those skilled in the art can obtain other drawings according to the attached drawings below without any creative work.

FIG. 1 is a flowchart illustrating a method of recovering hard disk data in a server provided in an embodiment of the disclosure.

FIG. 2 is a schematic drawing illustrating the relation among a chunk, a file and a sector in accordance with an embodiment of the disclosure.

FIG. 3 is a flowchart of a method for recovering hard disk data in a server provided in an embodiment of the disclosure.

FIG. 4 is a flowchart of an online recovery method for hard disk data in a server provided in an embodiment of the disclosure.

FIG. 5 is a flowchart of an offline recovery method for hard disk data in a server provided in an embodiment of the disclosure.

FIG. 6 is a schematic drawing illustrating the structure of a server provided in an embodiment of the disclosure.

FIG. 7 is a schematic drawing illustrating the structure of a server provided in an embodiment of the disclosure.

### DETAILED DESCRIPTION OF THE DISCLOSURE

In order to better clarify the purpose, technical solution and advantage of the disclosure, detailed descriptions are given below based on embodiments of the disclosure in combination with the accompanying drawings.

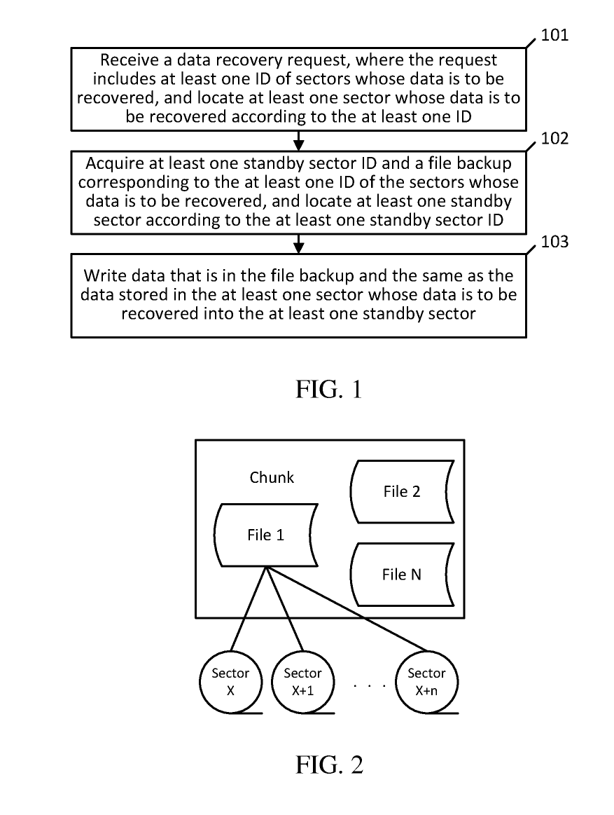

As shown in FIG. 1, an embodiment of the disclosure provides a method of recovering hard disk data for a server, including:

101: Receive a data recovery request. The request includes at least one identify (ID) of sectors whose data is to be recovered. Based on the at least one ID of the sectors whose data is to be recovered, at least one sector whose data is to be recovered is located.

102: Acquire at least one standby sector ID and a file backup corresponding to the at least one ID of the sectors whose data is to be recovered, and locate at least one standby sector based on the at least one standby sector ID.

103: Write, into the at least one standby sector, data that is in the file backup and the same as the data stored in the at least one sector whose data is to be recovered.

The technical solution provided by the embodiment of the disclosure has the following benefits. By receiving the data recovery request including at least one ID of sectors whose data is to be recovered, at least one sector whose data is to be recovered is located based on the at least one ID of the sectors whose data is to be recovered. Obtain at least one standby sector ID and a file backup corresponding to the at least one ID of the sectors whose data is to be recovered, and locate at least one standby sector based on the at least one standby sector ID. Since the size of the file backup is small relative to the entire hard disk data, the file backup can be obtained quickly, and data that is in the file backup and the same as the data stored in the at least one sector whose data is to be recovered can be written into the at least one standby sector. The data stored in the sectors whose data is to be recovered can be quickly recovered by using standby sectors of a hard disk. The cost of business operations is reduced by eliminating the necessity of changing the entire hard disk.

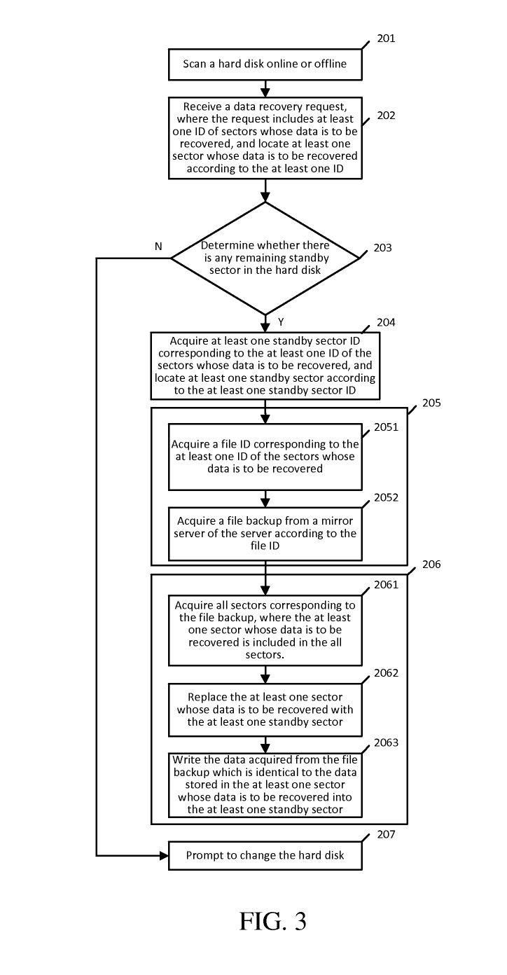

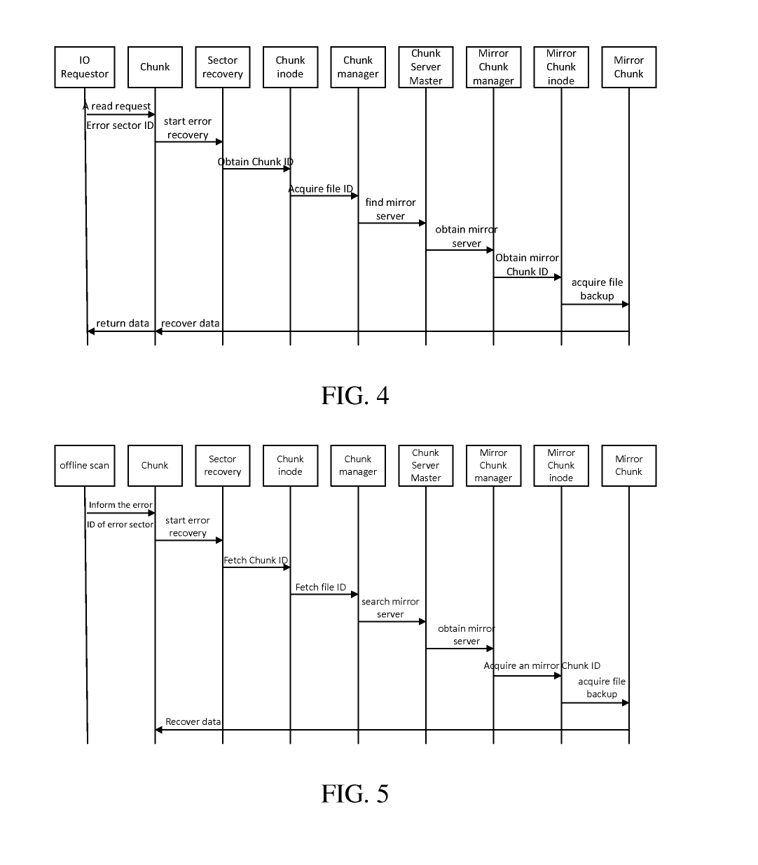

In order to facilitate the description of technical solution in an embodiment of the disclosure, a chunk server is described first. In a distributed storage system, the chunk server stores mass user data. In order to provide data protection, the same contents are usually stored on at least two chunk servers and updated synchronously. In the two or more chunk servers, one is called a master server, and the rest are called mirror servers. Chunk is a data storage unit defined for a chunk server. It may be referred to FIG. 2 that, on the one hand, a chunk at least includes a file, i.e., a chunk may correspond to several files stored on the local hard disk. On the other hand, a file is stored on one sector or at least two continuous sectors on the local hard disk, i.e., a chunk may include many continuous sectors. Based on the above definitions, referring to FIGS. 3-5, a process for recovering hard disk data in a server may be provided in accordance with the embodiment of the disclosure.

201: Scan a hard disk online or offline.

In an example, the hard disk is scanned online or offline, in order to check if there is any sector whose data is to be recovered in the hard disk. If yes, a data recovery request is triggered, and the request includes at least one ID of sectors having data to be recovered. The sector ID is a logic address of the sector. Obviously, the logic address may be converted to a physical address via a computer.

Online hard disk scanning is hard disk reading and writing occurred when a chunk server is working. Hard disk reading and writing are mainly caused by data input and output with an upper layer application by the chunk server. The upper layer application need to retrieve the data stored on the chunk server in order to achieve some functions requested by users. Concretely, the upper layer application sends a reading operation (data output) request to the chunk server, and the request includes at least one data storage sector ID. Once the chunk server receives the reading operation request, it acquires corresponding data from a sector according to the sector ID and then returns the data to the upper layer application. When the data storage sector can not be read, the chunk server can not acquire corresponding data and will trigger a data recovery request. The data recovery request includes at least one ID of sectors, wherein data on the sectors is to be recovered, i.e., a data storage sector ID.

Offline hard disk scanning is a self-check function of the hard disk. When the hard disk is working, it can monitor the operating status of all components and give warning in the case of any abnormality via corresponding software on the computer. The self-check function of the hard disk adopts relevant hard disk data security technology. Currently, the commonly used hard disk data security technology is S.M.A.R.T (Self-Monitoring Analysis and Reporting Technology). It provides a scanning function that can scan all sectors, and mark and screen any sector that can not be read or written.

When the hard disk of the host of the chunk server is idle, S.M.A.R.T scanning function of the hard disk can be launched. When S.M.A.R.T identifies any sector that can not be read, it will record the sector ID and trigger a data recovery request. The data recovery request includes IDs of all sectors that can not be read, i.e., IDs of sectors whose data is to be recovered. To be specific, taking a SATA (Serial Advanced Technology Attachment) hard disk as an example, the chunk server can use an ATA command, SMART (B0H); a subcommand, SMART EXECUTE OFF-LINE IMMEDIATE (D4H) to launch the S.M.A.R.T scanning function.

202: Receive a data recovery request. The data recovery request includes at least one ID of sectors of which data is to be recovered. Based on the at least one ID of the sectors of which data is to be recovered, at least one sector having data to be recovered is located.

Specifically, the data recovery request is received, and then the at least one ID of the sectors whose data is to be recovered included in the request is acquired. Since one ID of a sector whose data is to be recovered uniquely identifies the sector whose data is to be recovered, at least one sector whose data is to be recovered can be found according to the at least one ID of the sectors whose data is to be recovered.

203: Determine whether there is any remaining standby sector in the hard disk.

If yes, execute 204. If not, execute 207.

Generally, some standby sectors are preset in the hard disk before delivery. Such standby sectors are substitute sectors reserved for damaged sectors. The number of standby sectors in a hard disk is limited. To judge if there is any remaining standby sector in the hard disk, a test may be carried out to find whether the standby sectors in the hard disk are used up. To be specific, a threshold value can be set for the remaining quantity of standby sectors. When the actual quantity of remaining standby sectors is greater than the threshold value, it is determined that the hard disk has remaining standby sectors, execute 204. If the actual quantity of remaining standby sectors is equivalent to or below the threshold value, it is determined that the hard disk has no remaining standby sectors, and then execute 207.

Further, S.M.A.R.T has a standby sector management function. When the number of remaining standby sectors is equivalent to or below the threshold value, S.M.A.R.T can give warning in advance through corresponding software. Therefore, the procedure can be executed by calling S.M.A.R.T. For example, launch a daemon to detect S.M.A.R.T warning information in real time. If there is no warning information, there are still some standby sectors remained.

204: Acquire at least one standby sector ID corresponding to the at least one ID of the sectors whose data is to be recovered, and locate at least one standby sector according to the at least one standby sector ID.

If there is any remaining standby sector in the hard disk, request the hard disk to allocate the same number of standby sectors selected from the remaining standby sectors as the number of the sectors whose data is to be recovered. The hard disk will allocate at least one standby sector for the at least one ID of the sectors whose data is to be recovered.

Accordingly, acquire at least one standby sector ID corresponding to the at least one standby sector allocated by the hard disk, locate at least one standby sector according to the at least one standby sector ID acquired, and then execute 205.

205: According to the at least one ID of the sectors whose data is to be recovered, acquire a file backup corresponding to the at least one ID of the sectors whose data is to be recovered. After completion of this procedure, execute 206. Further, this procedure includes:

2051: According to the at least one ID of the sectors whose data is to be recovered, acquire a file ID corresponding to the at least one ID of the sectors whose data is to be recovered.

2051a: According to the at least one ID of the sectors whose data is to be recovered, acquire a chunk ID corresponding to the at least one ID of the sectors whose data is to be recovered.

The at least one ID of the sectors whose data is to be recovered and the chunk ID have a corresponding relationship.

In the chunk server, each chunk includes a plurality of continuous sectors. Each chunk has a corresponding relationship with each sector the chunk includes. After acquiring at least one ID of sectors whose data is to be recovered, acquire a chunk ID corresponding to the at least one ID of the sectors whose data is to be recovered according to the corresponding relationship. To be specific, corresponding relationships of the chunk and sectors included in the chunk are stored in the chunk server and managed by a chunk inode.

2051b: According to the chunk ID and the at least one ID of the sectors whose data is to be recovered, acquire a file ID corresponding to the at least one ID of the sectors whose data is to be recovered.

The Chunk ID and the ID of the sector whose data is to be recovered have a corresponding relationship with the file ID.

In the chunk server, a file is stored on at least one sector, and a chunk includes at least one file. The Chunk ID and the ID of the sector whose data is to be recovered have a corresponding relationship with the file ID. The corresponding relationship of the three IDs is stored in the chunk server and managed by a chunk manager. Once the chunk ID and the ID of the sector whose data is to be recovered are acquired, the file ID corresponding to the sector whose data is to be recovered can be acquired according to the corresponding relationship. Specifically, IDs of all files included in the chunk can be acquired. The file ID corresponding to the at least one ID of the sectors whose data is to be recovered can be selected from all the file IDs according to the at least one ID of the sectors whose data is to be recovered.

2052: According to the file ID, acquire a file backup from a mirror server of the aforementioned server.

2052a: Acquire the chunk ID corresponding to the file backup from the mirror server of the aforementioned server according to the file ID.

The file backup is a backup corresponding to the at least one sector whose data is to be recovered.

In an example, the mirror server corresponds to the chunk server on which the file is stored. The file backup is stored in a chunk of the mirror server. Therefore, before acquiring the file backup, acquire the corresponding Chunk ID of the file backup first. Specifically, read the Chunk Server ID and then acquire a mirror server ID through a Chunk Server Master. In a distributed storage system, the Chunk Server Master manages the operation of all Chunk Servers, including a corresponding relationship of a Chunk Server and a mirror server. Then, according to the file ID, acquire the corresponding Chunk ID of the file backup from the mirror server.

2052b: Acquire the file backup according to the chunk ID corresponding to the file backup.

After acquiring the corresponding chunk ID of the file backup, acquire the file backup corresponding to the file from the chunk according to the file ID. Specifically, the file backup can be copied from the chunk.

206: Write the same data in the file backup and stored in the at least one sector whose data is to be recovered into the standby sector. Further, this procedure includes:

2061: Acquire all sectors corresponding to the file backup.

The at least one sector whose data is to be recovered is included in all the sectors corresponding to the file backup.

All the sectors corresponding to the file backup are all sectors corresponding to the original file of the backup. Acquire all the sectors corresponding to the original file. Specifically, according to the file ID acquired via 2051, IDs of all sectors corresponding to the file can be acquired from a file-sector correspondence table. The IDs of all the sectors include the at least one ID of the sectors whose data is to be recovered. The file-sector correspondence table includes a corresponding relationship of each file and all sectors on which the file is stored. Further, the file-sector correspondence table also stores a time sequence concerning data storage and reading of all sectors that store the file. The correspondence table is stored in the Chunk Server. Obviously, when a file is written into the hard disk, the hard disk will allocate a certain number of sectors according to the file size. Besides, a corresponding relationship between the file and all storage sectors will be added to the file-sector correspondence table. It should be noted that this procedure can be executed after 2051.

2062: Replace the at least one sector whose data is to be recovered with at least one standby sector.

After acquiring all sectors corresponding to the file, replace the at least one sector whose data is to be recovered with the at least one standby sector. That is, reallocate or change the corresponding relationship between the file and the at least one sector whose data is to be recovered into the corresponding relationship between the file and the at least one standby sector. Specifically, in the above file-sector correspondence table, update the ID of the sector whose data is to be recovered to a standby sector ID.

2063: Write the data acquired from the file backup which is identical to the data stored in the sector whose data is to be recovered into the at least one standby sector.

Herein, write the file backup into all the replaced sectors, i.e., overwrite the original file with the file backup. In this way, the data in the file backup corresponding to the at least one sector whose data is to be recovered is written into the at least one standby sector. Obviously, when the data corresponding to the sector whose data is to be recovered needs to be read afterwards, read the data from the standby sector.

It is required to rewrite the file influenced by the damaged sector, while not required to recover the whole hard disk data. The procedure depends on the file size. Taking the typical size of an online image of 200 KB as an example, the procedure takes only less than a second to recover the data, which improves the hard disk data recovery efficiency. It should be noted that a remapping function of S.M.A.R.T may be adopted in 205. Therefore, this procedure can be executed by calling S.M.A.R.T and will not be described in detail again.

207: Prompt to change the hard disk.

If reserved sectors on the hard disk have been used up, the hard disk can not allocate reserved sectors then, and will exit the data recovery process and prompt an administrator to replace the hard disk of the chunk server.

The technical solution provided by the embodiment of the disclosure has the following benefits. By receiving the data recovery request including at least one ID of sectors whose data is to be recovered, at least one sector whose data is to be recovered is located based on the at least one ID of the sectors whose data is to be recovered. Obtain at least one standby sector ID and a file backup corresponding to the at least one ID of the sectors whose data is to be recovered, and locate at least one standby sector based on the at least one standby sector ID. Since the size of the file backup is small relative to the entire hard disk data, the file backup can be obtained quickly, and data that is in the file backup and the same as the data stored in the at least one sector whose data is to be recovered can be written into the at least one standby sector. The data stored in the sectors whose data is to be recovered can be quickly recovered by using standby sectors of a hard disk. The cost of business operations is reduced by eliminating the necessity of changing the entire hard disk.

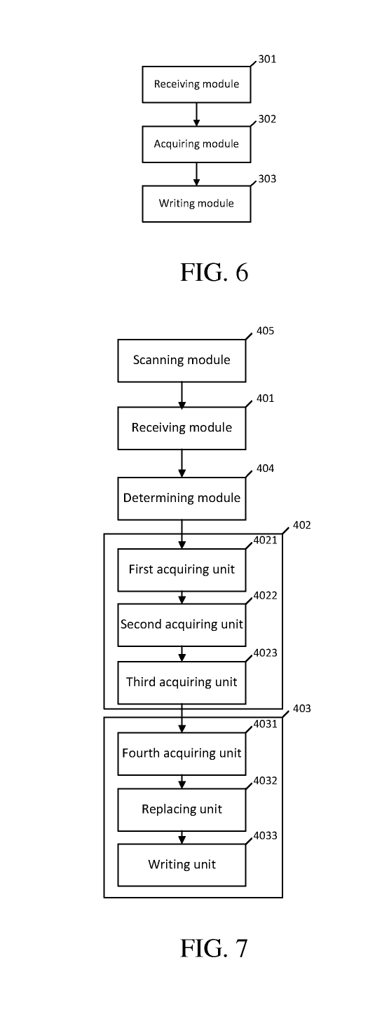

Refer to FIG. 6, an embodiment of the disclosure provides a server including the following modules.

A receiving module 301 is configured to receive a data recovery request. The request includes at least one ID of sectors whose data is to be recovered. Based on the at least one ID of the sectors whose data is to be recovered, at least one sector whose data is to be recovered is located.

An acquiring module 302 is configured to acquire at least one standby sector ID and a file backup corresponding to the at least one ID of the sectors whose data is to be recovered, and locate at least one standby sector based on the at least one standby sector ID.

A writing module 303 is configured to write data that is in the file backup and the same as the data stored in the at least one sector whose data is to be recovered into the at least one standby sector.

The technical solution provided by the embodiment of the disclosure has the following benefits. By receiving the data recovery request including at least one ID of sectors whose data is to be recovered, at least one sector whose data is to be recovered is located based on the at least one ID of the sectors whose data is to be recovered. Obtain at least one standby sector ID and a file backup corresponding to the at least one ID of the sectors whose data is to be recovered, and locate at least one standby sector based on the at least one standby sector ID. Since the size of the file backup is small relative to the entire hard disk data, the file backup can be obtained quickly, and the data that is in the file backup and the same as the data stored in the at least one sector whose data is to be recovered can be written into the at least one standby sector. Data stored in sectors whose data is to be recovered can be quickly recovered by using standby sectors of a hard disk. In this way, the cost of business operations is reduced by eliminating the necessity of changing the entire hard disk.

Refer to FIG. 7, an embodiment of the disclosure provides a server including the following modules.

A receiving module 401 receives a data recovery request. The request includes at least one ID of sectors whose data is to be recovered. Based on the at least one ID of the sectors whose data is to be recovered, at least one sector whose data is to be recovered is located.

An acquiring module 402 acquires at least one standby sector ID and a file backup corresponding to the at least one ID of the sectors whose data is to be recovered, and locate at least one standby sector based on the at least one standby sector ID.

In an example, the acquiring module 402 includes the following units.

A first acquiring unit 4021 acquires the at least one standby sector ID corresponding to the at least one ID of the sectors whose data is to be recovered, and locate the at least one standby sector according to the at least one standby sector ID.

A second acquiring unit 4022 acquires a file ID corresponding to the at least one ID of the sectors whose data is to be recovered according to the at least one ID of the sectors whose data is to be recovered.

A third acquiring unit 4023 acquires the file backup from a mirror server of the server according to the file ID.

A writing module 403 writes data in the file backup identical to the data stored in the at least one sector whose data is to be recovered into the at least one standby sector.

The writing module 403 includes the following units.

A fourth acquiring unit 4031 is configured to acquire all sectors corresponding to the file backup, and the at least one sector whose data is to be recovered is included in the sectors corresponding to the file backup.

A replacing unit 4032 is configured to replace the at least one sector whose data is to be recovered with the at least one standby sector.

A writing unit 4033 is configured to acquire the data in the file backup identical to the data stored in the at least one sector whose data is to be recovered, and write the data to the at least one standby sector.

The server also includes: a determining module 404, configured to determine whether the hard disk has any remaining standby sector. If no, prompt to replace the hard disk.

Accordingly, the first acquiring unit 4021 is further configured to obtain the at least standby sector ID corresponding to the at least one ID of the sectors whose data is to be recovered if there is any remaining standby sector.

The server also includes: a scanning module 405, configured to scan the hard disk online or offline.

The technical solution provided by the embodiment of the disclosure has the following benefits. By receiving the data recovery request including the at least one ID of the sectors whose data is to be recovered, at least one sector whose data is to be recovered is located based on the at least one ID of the sectors whose data is to be recovered. Obtain at least one standby sector ID and a file backup corresponding to the at least one ID of the sectors whose data is to be recovered, and locate at least one standby sector based on the at least one standby sector ID. Since the size of the file backup is small relative to the entire hard disk data, the file backup can be obtained quickly, and the data that is in the file backup and the same as the data stored in the at least one sector whose data is to be recovered can be written into the at least one standby sector. Data stored in sectors whose data is to be recovered can be quickly recovered by using standby sectors of a hard disk, thereby reducing the cost of business operations by eliminating the necessity of changing the entire hard disk.

An embodiment of the disclosure provides a distributed storage system which includes at least two servers. At least one server among the at least two servers is a mirror server of another server included in the at least two servers. The another server may be a server described in the previous embodiments.

The technical solution provided by the embodiment of the disclosure has the following benefits. By receiving the data recovery request including at least one ID of sectors whose data is to be recovered, at least one sector whose data is to be recovered is located based on the at least one ID of the sectors whose data is to be recovered. Obtain at least one standby sector ID and a file backup corresponding to the at least one ID of the sectors whose data is to be recovered, and locate at least one standby sector based on the at least one standby sector ID. Since the size of the file backup is small relative to the entire hard disk data, the file backup can be obtained quickly, and the data that is in the file backup and the same as the data stored in the at least one sector whose data is to be recovered can be written into the at least one standby sector. Data stored in sectors whose data is to be recovered can be quickly recovered by using standby sectors of a hard disk without changing the entire hard disk, thereby reducing the cost of business operations.

The server and the distributed storage system provided in the embodiments pertain to the same idea with the method embodiments. Details of the realization may be obtained from the method embodiments, which are not given repeatedly hereon.

Those skilled in the art can understand that all or part of processes to realize the embodiments may be implemented through hardware, or relevant hardware instructed by a program. The program can be stored in a computer readable storage media, such as a Read-Only Memory (ROM), a magnetic disk or a compact disk.

The above is only preferred embodiments of the disclosure, which is not used for restricting the disclosure. Any revision, equal substitution or improvement within the spirit and principle of the disclosure is included in the protection scope of the disclosure.

1. A method for recovering hard disk data for a server, comprising:
receiving a data recovery request, wherein the data recovery request comprises at least one identity (ID) of sectors whose data is to be recovered, and locating at least one sector whose data is to be recovered based on the at least one ID of the sectors whose data is to be recovered;
acquiring at least one standby sector ID and a file backup corresponding to the at least one ID of the sectors whose data is to be recovered, and locating at least one standby sector based on the at least one standby sector ID; and
writing data that is in the file backup and the same as the data stored in the at least one sector whose data is to be recovered into the at least one standby sector.

2. The method according to claim 1, wherein acquiring the file backup corresponding to the at least one ID of the sectors whose data is to be recovered comprises:
according to the at least one ID of the sectors whose data is to be recovered, acquiring a file ID corresponding to the at least one ID of the sectors whose data is to be recovered; and
acquiring the file backup according to the file ID from a mirror server of the server.

3. The method according to claim 1, wherein writing the data that is in the file backup and the same as the data stored in the at least one sector whose data is to be recovered into the at least one standby sector comprises:
obtaining all sectors corresponding to the file backup, wherein the all sectors comprise the at least one sector whose data is to be recovered;
replacing the at least one sector whose data is to be recovered with the at least one standby sector; and
obtaining data identical to the data stored in the at least one sector whose data is to be recovered from the file backup, and writing the obtained data into the at least one standby sector.

4. The method according to claim 1, further comprising:
after receiving the data recovery request, determining whether the hard disk has a remaining standby sector, and prompting to replace the hard disk if there is no standby sector remained.

5. The method according to claim 1, further comprising:
before receiving the data recovery request, scanning the hard disk online or offline.

6. A server, comprising:
a receiving module, configured to receive a data recovery request, wherein the data recovery request comprises at least one ID of sectors whose data is to be recovered, and locate at least one sector whose data is to be recovered based on the at least one ID of the sectors whose data is to be recovered;
an acquiring module, configured to acquire at least one standby sector ID and a file backup corresponding to the at least one ID of the sectors whose data is to be recovered, and locate at least one standby sector based on the at least one standby sector ID; and
a writing module, configured to write data that is in the file backup and the same as the data stored in the at least one sector whose data is to be recovered into the at least one standby sector.

7. The server according to claim 6, wherein the acquiring module comprises:
a first acquiring unit, configured to acquire at least one standby sector ID corresponding to the at least one ID of the sectors whose data is to be recovered, and locate at least one standby sector according to the at least one standby sector ID;
a second acquiring unit, configured to acquire a file ID corresponding to the at least one ID of the sectors whose data is to be recovered according to the at least one ID of the sectors whose data is to be recovered; and
a third acquiring unit, configured to acquire the file backup from a mirror server of the server according to the file ID.

8. The server according to claim 6, wherein the writing module comprises:
a fourth acquiring unit, configured to acquire all sectors corresponding to the file backup, wherein the all sectors comprise the at least one sector whose data is to be recovered;
a replacing unit, configured to replace the at least one sector whose data is to be recovered with the at least one standby sector; and
a writing unit, configured to acquire data in the file backup identical to the data stored in the at least one sector whose data is to be recovered, and write the acquired data to the at least one standby sector.

9. The server according to claim 6, further comprising:
a determining module, configured to determine whether the hard disk has any remaining standby sector, and promote to replace the hard disk if there is no standby sector remained.

10. The server according to claim 6, further comprising:
a scanning module, configured to scan the hard disk online or offline.

11. A distributed storage system, comprising: at least two servers;
wherein at least one server among the at least two servers is a mirror server of another server among the at least two servers, and the another server is the server as claimed in claim 6.
